(19) United States
(12) Patent Application Publication
(10) Pub. No.: US 2015/0132713 A1
(43) Pub. Date: May 14, 2015

(54) DENTAL HANDPIECE WITH VORTEX-WASHER-DRIVEN PARTICULATE DISCHARGE

(71) Applicant: DentalEZ, Inc., Malvern, PA (US)

(72) Inventor: Luther GATES, Honey Brook, PA (US)

(73) Assignee: DentalEZ, Inc., Malvern, PA (US)

(21) Appl. No.: 14/074,834

(22) Filed: Nov. 8, 2013

(51) Int. Cl. A61C 1/08; A61C 3/02; A61C 1/05

(52) U.S. Cl. CPC A61C 1/08; A61C 1/05; A61C 3/02
USPC 433/91

(57) ABSTRACT

A dental handpiece has a turbine head housing a chuck assembly with a burr tube secured to and rotated by a gas-driven handpiece motor assembly supported by a bearing assembly having a first bearing. A portion of the burr tube passes through the housing end wall forming an opening concentric with and spaced from the burr tube. A cavity is formed in the housing by a first lateral face of a first flange of an outer race of the first bearing, a first end of the housing sidewall and a housing end wall. The cavity is in fluid communication with the opening in the end wall and a vent in the housing side wall. A vortex washer disposed in the cavity and fixed to the burr tube for rotation therewith draws dental worksite particulate through the opening and into the cavity and discharges the particulate through the vent.

### BACKGROUND OF THE INVENTION

The present invention relates to a dental handpiece having a turbine head containing high-speed turbine for rotating a dental workpiece drill burr. More particularly, the present invention relates to dental handpiece having a turbine head with a vortex-washer-driven particulate discharge.

During a dental procedure involving the application of a rotating dental workpiece to a dental worksite, particulate matter from the worksite may be introduced in the air reducing or obscuring visibility of the worksite. This problem is commonly mitigated by the presence of a suction device proximal to the worksite. The suction device, itself, may also block visibility of the worksite.

Accordingly, there is a need in the art for a dental handpiece having a turbine head that is able to remove small particulate entrained in the air proximal to the worksite.

### BRIEF SUMMARY OF THE INVENTION

Briefly stated, one embodiment of the present invention is directed to a dental handpiece for rotating a dental workpiece has a housing having a generally cylindrical housing side wall terminating at a first end having a housing end wall. A gas-driven handpiece motor assembly includes a rotor shaft having an axis of rotation substantially coincident with a central longitudinal axis of the housing. A chuck assembly is secured to the rotor shaft. The chuck assembly has a burr tube configured to releasably hold the dental workpiece. A portion of the burr tube passes through the housing end wall forming an opening concentric with and spaced from the burr tube. A bearing assembly radially supports the motor assembly. The bearing assembly has a first hearing disposed toward and supported by the first end of the housing and includes an inner race fixed to the burr tube and an outer race having an inner wall facing radially inwardly toward the axis of the rotor shaft. A first flange is connected to a first end of the inner wall of the outer race and extends radially inwardly of the inner wall in a plane substantially perpendicular to the axis of the rotor shaft. The first flange has a lateral face disposed toward the housing end wall. A cavity is formed by the first lateral face of the first flange, the first end of the housing and the housing end wall. The cavity is in fluid communication with the opening in the housing end wall and a vent in the first end of the housing. A vortex washer is disposed in the cavity and fixed to the burr tube.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, the drawings show embodiments which are presently preferred. It should be understood, however, that the invention is not limited to the precise arrangements and instrumentalities shown.

In the drawings:

FIG. 1 is a side elevation view in cross-section of an angle-headed dental handpiece having a preferred embodiment of a turbine head with a vortex-washer-driven particulate discharge in accordance with the present invention;

FIG. 2 is an enlarged side elevation view in cross-section of the turbine head of the dental headpiece of FIG. 1;

FIG. 3 is an enlarged side elevation view in cross-section of a portion of the turbine head of FIG. 2 showing the vortex-washer-driven particulate discharge; and

FIGS. 4A and 4B are an enlarged side elevation view in cross-section and top plan view, respectively of the vortex washer of FIG. 3.

### DETAILED DESCRIPTION OF THE INVENTION

Reference will now be made in detail to embodiments of the invention, examples of which are illustrated in the accompanying drawings. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The words “and/or” as used herein refers to and encompasses any and all possible combinations of one or more of the associated listed items. The words “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The words “right,” “left,” “lower” and “upper” designate directions in the drawings to which reference is made. The words “inwardly” and “outwardly” refer to directions toward and away from, respectively, the geometric center of the dental handpiece, and designated parts thereof. The terminology includes the words noted above, derivatives thereof and words of similar import.

Although the words first, second, etc., are used herein to describe various elements, these elements should not be limited by these words. These words are only used to distinguish one element from another. For example, a first bearing could be termed a second bearing, and, similarly, a second bearing could be termed a first bearing, without departing from the scope of the present invention.

The following description is directed towards various embodiments of a dental handpiece in accordance with the present invention.

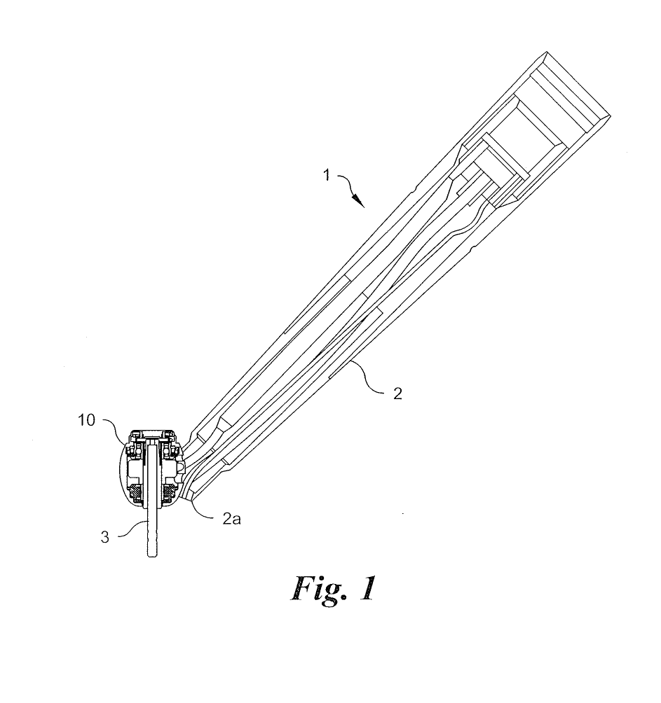

Referring to the drawings in detail, where like numerals indicate like elements throughout, there is shown in FIGS. 1-4 a first preferred embodiment of the dental handpiece with vortex-washer-driven particulate discharge, generally designated 1, and hereinafter referred to as the “dental handpiece” 1 in accordance with the present invention.

The dental handpiece 1 includes an elongated tubular housing 2 which terminates at a first end 2a in a turbine head 10 attached at an angle to the tubular housing 2. A dental workpiece 3, such as the drill burr shown in FIG. 1, is installable in the turbine head 10.

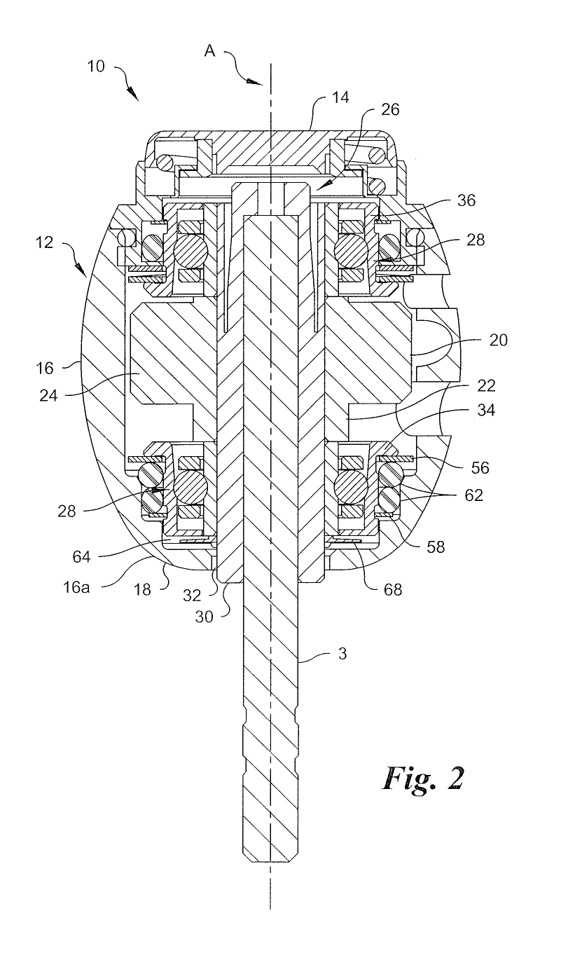

Referring to FIG. 2, the turbine head 10 is shown in a side elevation cross-sectional view. The turbine head 10 has a turbine head housing 12 having a central longitudinal axis “A”. A generally flat turbine head endcap 14 removably attaches to the turbine head housing 12. The housing 12 has a generally cylindrical housing side wall 16 terminating at a first side wall end 16a having a generally flat housing end wall 18.

A gas-driven turbine motor assembly 20 is disposed in the turbine head housing 12.

The turbine motor assembly 20 has a turbine rotor shaft 22 supporting a plurality of turbine vanes 24. The turbine rotor shaft 22 has an axis of rotation substantially coincident with the central longitudinal axis “A” of the turbine head 12. The turbine motor assembly 20 further includes a chuck assembly 26 and a bearing assembly 28. The chuck assembly 26 has a burr tube 30 secured to the turbine rotor for rotation wherewith. The burr tube 30 is configured to releasably hold the dental workpiece 3. A portion of the burr tube 30 passes through the housing end wall 18 and forms an opening 32 concentric with and spaced from the burr tube 30. The bearing assembly 28 supports the burr tube and has a first bearing 34 disposed toward and supported by the first end 12a of the turbine head housing 12 and a second bearing 36 disposed toward the turbine head endcap 14 and supported by a portion of the housing side wall 16 proximal to the turbine head endcap 14.

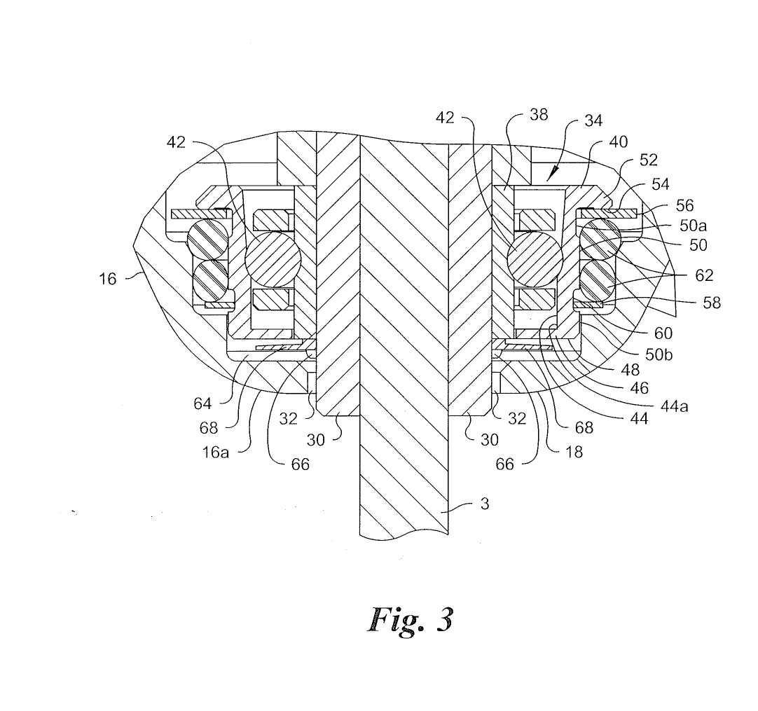

Referring to FIG. 3, an enlarged side elevation view in cross-section of a portion of the turbine head 10 of FIG. 2 is shown.

The first bearing assembly 34 has an annular inner race 38 fixed to the burr tube 30. and an annular outer race 40 . A set of bearing elements 42 are confined between and in frictional engagement with the inner and outer races 38, 40. The outer race 40 has an inner wall 44 facing radially inwardly toward the axis of the rotor shaft 22. A first flange 46 is connected to a first end 44a of the inner wall 44 of the outer race 40. The first flange 46 extends radially inwardly from the inner wall 44 in a plane substantially perpendicular to the axis of the rotor shaft. The first flange 46 has a lateral face 48 disposed toward the housing end wall 18.

The outer race 40 has an outer wall 50 facing radially outwardly of the axis of rotation of the rotor shaft 22. A second flange 52 is connected to a first end 50a of the outer wall 50 of the outer race 40. The second flange 52 extends radially outwardly from the outer wall 40 in a plane substantially perpendicular to the axis of the rotor shaft 22. The second flange 52 has a first lateral face 54 disposed toward the first end 16a of the housing side wall 16. A substantially flat washer 56 couples the first lateral face 54 of the second flange 53 to a portion of the housing sidewall 16. A snap ring 58 in a circumferential groove 60 proximal to a second end 50b of the outer wall 40 couples the outer race 40 to a portion of the housing sidewall 16. A pair of rings 62 fabricated from a resilient mater is disposed between the substantially flat washer 56 and the snap ring 58 and provide a compressive fit between the outer wall 40 and a portion of the housing sidewall 16.

A cavity 64 is formed by the first lateral face 48 of the first flange 46, the first end 16a of the housing sidewall 16 and the housing end wall 18. The cavity 64 is in fluid communication with the opening 32 in the housing end wall 18 and a vent 66 to atmosphere in the first end 16a of the housing 16. In some embodiments, the first end 16a of the housing 16 has a plurality of spaced apart vents 66 in fluid communication with the cavity 64.

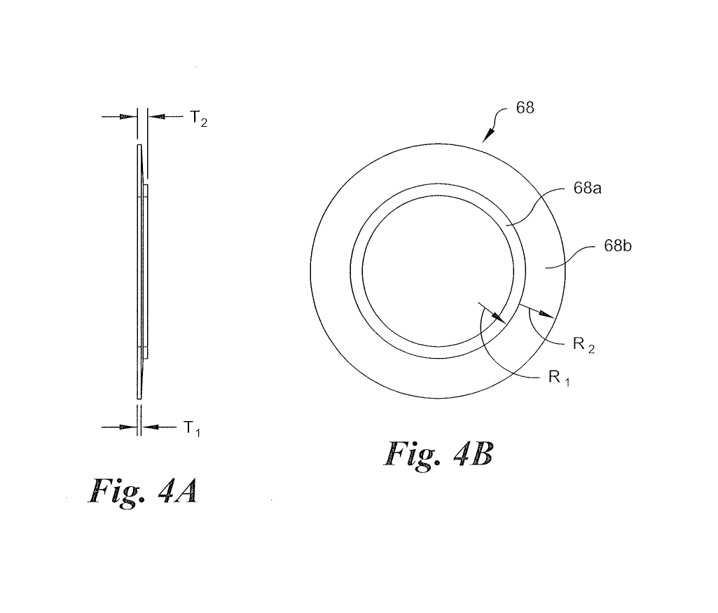

A vortex washer 68 is disposed in the cavity 64 and fixed to the burr tube 30. Preferably, the vortex washer 68 is fixed to the burr tube 30 by a press or compression fit. The vortex washer 68 extends radially outwardly of the burr tube 30 in a plane substantially perpendicular to the axis “A” of the turbine head “A”. Preferably, in some embodiments the vortex washer 68 adjoins the inner race 38. In other embodiments, the vortex washer 68 may be spaced from the inner race 38. Although in some embodiments, the vortex washer 68 may have a uniform thickness, in a preferred embodiment, the vortex washer 68 comprises an inner portion 68a extending outwardly a first radius R₁ from the burr tube 30 and has a first thickness T₁ and an outer portion 68b extending outwardly from the burr tube 30 a second radius R₂ greater than the first radius R₁ and has a second thickness T₂ less than the first thickness T₁. (See, FIGS. 4A and 4B)

During use of the dental handpiece 1, when pressurized drive air is applied to the turbine motor assembly 20, the turbine vanes rotates causing the burr tube 30 with the vortex washer 68 fixed thereto to rotate in turn. As the vortex washer 68 rotates, the concentric opening 32 in the housing end wall 18 functions as an inlet port through which air outside the turbine head housing 12 proximal to the housing end wall 18 is drawn into the cavity 64 and forced by the rotation of the vortex washer 68 out of the cavity through the vent 66 which functions as an outlet port in the first end 16a of the housing sidewall 16a. Small particulate entrained in the air flow is therefore drawn from the dental work site into the cavity 64 and discharged through the air vent 66.

The foregoing detailed description of the invention has been disclosed with reference to specific embodiments. However, the disclosure is not intended to be exhaustive or to limit the invention to the precise forms disclosed. Those skilled in the art will appreciate that changes could be made to the embodiments described above without departing from the broad inventive concept thereof. Therefore, the disclosure is intended to cover modifications within the spirit and scope of the present invention as defined by the appended claims.

1. A dental handpiece for rotating a dental workpiece comprising:
a housing having a generally cylindrical housing side wall terminating at a first end having a housing end wall;
a gas-driven handpiece motor assembly including a rotor shaft having an axis of rotation substantially coincident with a central longitudinal axis of the housing;
a chuck assembly secured to the rotor shaft, the chuck assembly having a burr tube configured to releasably hold the dental workpiece, a portion of the burr tube passing through the housing end wall and forming an opening concentric with and spaced from the housing end wall;
a bearing assembly radially supporting the motor assembly, the bearing assembly having a first bearing disposed toward and supported by the first end of the housing and including:
an inner race fixed to the burr tube ;
an outer race having an inner wall facing radially inwardly toward the axis of the rotor shaft;
a first flange integral with a first end of the inner wall of the outer race and extending radially inwardly from the inner wall in a plane substantially perpendicular to the axis of the rotor shaft, the first flange having a lateral face disposed toward the housing end wall;
a cavity formed by the first lateral face of the first flange, the first end of the housing and the housing end wall, the cavity in fluid communication with the opening in the housing end wall and a vent in the first end of the housing; and
a vortex washer fixed to the burr tube for rotation therewith and extending radially outwardly in the cavity in a plane substantially perpendicular to the axis of the rotor shaft.

2. The dental handpiece according to claim 1, wherein the washer adjoins the inner race.

3. The dental handpiece according to claim 1, wherein the washer extends radially outwardly of the burr tube in a plane substantially perpendicular to the axis of the rotor shaft.

4. The dental handpiece according to claim 1, wherein the washer comprises an inner portion having a first radius and a first thickness and an outer portion having a second radius greater than the first radius and a second thickness less than the first thickness.

5. The dental handpiece according to claim 1, wherein the inner race of the first bearing and the washer are fixed to the burr tube by a press fit and the washer adjoins the inner race.

6. The dental handpiece according to claim 1, wherein the first end of the housing has a plurality of vents in fluid communication with the cavity.

7. The dental handpiece according to claim 1, wherein the opening in the housing end wall is an inlet port, the vent in the first end of the housing is an outlet port and air outside the housing proximal to the first end of the housing is drawn through the opening in the housing end wall into the cavity and forced by the vortex washer through the outlet port when the gas-driven handpiece motor assembly is driven by air supplied under pressure.
